(19) United States
(12) Patent Application Publication
(10) Pub. No.: US 2003/0120800 A1
(43) Pub. Date: Jun. 26, 2003

(54) Network layer protocol

(75) Inventors: Andrew Novetzke, Sarasota, FL (US); Peter Montgomery, Owen Sound (CA); Richard Chmielewski, Oneco, FL (US); Doug Price, Ontario (CA)

Correspondence Address: BAKER & HOSTETLER LLP, Suite 1100, Washington Square, 1050 Connecticut Avenue, N.W., Washington, DC, 20036, US

(73) Assignee: Edwards Systens Technology, Inc.

(21) Appl. No.: 10/307,965

(22) Filed: Dec. 3, 2002

Related U.S. Application Data
(60) Provisional application No. 60/336,146, filed on Dec. 6, 2001.

(51) Int. Cl. G06F 15/16

(52) U.S. Cl. 709/236; 709/228

(57) ABSTRACT

Method and apparatus of a network protocol that provides the network, transport, session and presentation layers of the open systems interconnection model.

### PRIORITY

This application claims priority to the provisional patent application, 60/336,146 filed Dec. 6,2001, the disclosure of which is incorporated herein by reference.

### FIELD OF THE INVENTION

The present invention relates generally to computer system network messaging protocols. More particularly, the present invention relates to a network layer protocol for supporting message transport and relays.

### BACKGROUND OF THE INVENTION

A computer network is a collection of autonomous computers connected together to permit sharing of hardware and software resources to increase overall reliability. The qualifying term “local area” is usually applied to computer networks in which the computers are located in a single building or in nearby buildings, such as on a college campus or at a single corporate site. This is also termed a local area network (LAN). When the computers are further apart, the terms “wide area network” or “long haul network” are used, but the distinction is one of degree and the definitions sometimes overlap.

A bridge is a device that is connected to at least two LANs and serves to pass message frames or packets between LANs, such that a source station on one LAN can transmit data to a destination station on another LAN, without concern for the location of the destination. Bridges are useful and necessary network components, principally because the total number of stations on a single LAN is limited. Bridges can be implemented to operate at a selected layer of protocol of the network. A detailed knowledge of network architecture is not needed for an understanding of this invention, but a brief description follows by way of further background.

At the heart of any computer network is a communication protocol. A protocol is a set of conventions or rules that govern the transfer of data between computer devices. The simplest protocols define only a hardware configuration, while more complex protocols define timing, data formats, error detection, correction techniques and software structures.

Computer networks almost universally employ multiple layers of protocols. A low-level physical layer protocol assures the transmission and reception of a data stream between two devices. Data packets are constructed in a data link layer. Over the physical layer, a network and transport layer protocol governs transmission of data through the network, thereby ensuring end-to end reliable data delivery.

The most common physical networking protocol or topology for small networks is Ethernet, developed by XEROX. When a node possesses a packet to be transmitted through the network, the node monitors the backbone and transmits when the backbone becomes clear. There is no central backbone master device to grant requests to gain access to the backbone. While this type of multipoint topology facilitates rapid transmission of data when the backbone is lightly utilized, packet collisions may occur when the backbone is heavily utilized. In such circumstances, there is a greater chance that multiple nodes will detect that the backbone is clear and transmit their packets coincidentally. If packets are impaired in a collision, the packets are retransmitted until transmission is successful.

Another conventional physical protocol or topology is Token Ring, developed by IBM. This topology employs a “token” that is passed unidirectionally from node to node around an annular backbone. The node possessing the token is granted exclusive access to the backbone for a single packet transfer. While this topology reduces data collisions, the latency incurred while each node waits for the token translates into a slower data transmission rate than Ethernet when the network is lightly utilized.

As computer networks have developed, various approaches have been used in the choice of communication medium, network topology, message format, protocols for channel access, and so forth. Some of these approaches have emerged as de facto standards, but there is still no single standard for network communication. However, a model for network architectures has been proposed and widely accepted. It is known as the International Standards Organization (ISO) Open Systems Interconnection (OSI) reference model. The OSI reference model is not itself a network architecture. Rather it specifies a hierarchy of protocol layers and defines the function of each layer in the network. Each layer in one computer of the network carries on a conversation with the corresponding layer in another computer with which communication is taking place, in accordance with a protocol defining the rules of this communication. In reality, information is transferred down from layer to layer in one computer, then through the channel medium and back up the successive layers of the other computer. However, for purposes of design of the various layers and understanding their functions, it is easier to consider each of the layers as communicating with its counterpart at the same level, in a “horizontal” direction.

The lowest layer defined by the OSI model is called the physical layer, and is concerned with transmitting raw data bits over the communication channel. Design of the physical layer involves issues of electrical, mechanical or optical engineering, depending on the medium used for the communication channel. The layer next to the physical layer is called the data link layer. The main task of the data link layer is to transform the physical layer, which interfaces directly with the channel medium, into a communication link that appears error-free to the next layer above, known as the network layer. The data link layer performs such functions as structuring data into packets or frames, and attaching control information to the packets or frames, such as checksums for error detection, and packet numbers.

Although the data link layer is primarily independent of the nature of the physical transmission medium, certain aspects of the data link layer function are more dependent on the transmission medium. For this reason, the data link layer in some network architectures is divided into two sublayers: a logical link control sublayer, which performs all medium-independent functions of the data link layer, and a media access control (MAC) sublayer. This sublayer determines which station should get access to the communication channel when there are conflicting requests for access. The functions of the MAC layer are more likely to be dependent on the nature of the transmission medium.

Bridges may be designed to operate in the MAC sublayer. Further details may be found in “MAC Bridges,” P802.1D/D6, September 1988, a draft publication of IEEE Project 802 on Local and Metropolitan Area Network Standards, or in later drafts of this document.

The basic function of a bridge is to monitor all message traffic on all LANs to which it is connected, and to forward each detected message onto LANs other than the one from which the message was heard. Bridges also maintain a database of station locations, derived from the content of the messages being forwarded. Bridges are connected to LANs by paths known as “links.” After a bridge has been in operation for some time, it can associate practically every station with a particular link connecting the bridge to a LAN, and can then forward messages in a more efficient manner, transmitting only over the appropriate link. The bridge can also recognize a message that does not need to be forwarded, because the source and destination stations are both reached through the same link. Except for its function of “learning” station locations, or at least station directions, the bridge operates basically as a message repeater.

To prevent the formation of closed loops in bridged networks, IEEE draft publication P802.1D, referred to above, proposes a standard for a spanning tree algorithm that will connect the bridged network into a tree configuration, containing no closed loops, and spanning the entire network configuration. The spanning tree algorithm is executed periodically by the bridges on, the interconnected network, to ensure that the tree structure is maintained, even if the physical configuration of the network changes. Basically, the bridges execute the spanning tree algorithm by sending special messages to each other to establish the identity of a “root” bridge. The root bridge is selected, for convenience, as the one with the smallest numerical identification. The algorithm determines which links of the bridges are to be active and which are to be inactive, i.e., disabled, in configuring the tree structure. One more piece of terminology is needed to understand how the algorithm operates. Each LAN has a “designated” link, which means that one of the links connectable to the LAN is designated to carry traffic toward and away from the root bridge. The basis for this decision is similar to the basis for selecting the root bridge. The designated link is the one providing the least costly (shortest) path to the root bridge, with numerical bridge identification being used as a tie-breaker. Once the designated links are identified, the algorithm chooses two types of links to be activated or closed: first, for each LAN its designated link is chosen, and second, for each bridge a link that forms the “best path” to the root bridge is chosen, i.e., a link through which the bridge received a message giving the identity of the root bridge. All other links are inactivated. Execution of the algorithm results in interconnection of the LANs and bridges in a tree structure, i.e., one having no closed loops.

The “Internet” is a collection of networks, including Arpanet, NSFnet, regional networks such as NYsernet, local networks at a number of university and research institutions, and a number of military networks. The protocols generally referred to as Transmission Control Protocol/Internet Protocol (TCP/IP) were originally developed for use only through Arpanet and have subsequently become widely used in the industry. The protocols provide a set of services that permit users to communicate with each other across the entire Internet. The specific services that these protocols provide are not important to the present invention, but include file transfer, remote log-in, remote execution, remote printing, computer mail, and access to network file systems.

The basic function of the Transmission Control Protocol (TCP) is to make sure that commands and messages from an application protocol, such as computer mail, are sent to their desired destinations. TCP keeps track of what is sent, and retransmits anything that does not get to its destination correctly. If any message is too long to be sent as one “datagram,” TCP will split it into multiple datagrams and makes sure that they all arrive correctly and are reassembled for the application program at the receiving end. Since these functions are needed for many applications, they are collected into a separate protocol (TCP) rather than being part of each application. TCP is implemented in the transport layer of the OSI reference model.

The Internet Protocol (IP) is implemented in the network layer of the OSI reference model, and provides a basic service to TCP: delivering datagrams to their destinations. TCP simply hands IP a datagram with an intended destination; IP is unaware of any relationship between successive datagrams, and merely handles routing of each datagram to its destination. If the destination is a station connected to a different LAN, the IP makes use of routers to forward the message.

TCP/IP frequently uses a slight deviation from the seven-layer OSI model in that it may have five layers. These five layers are combinations and derivatives of the seven-layer model. The five layers are as follows:

Layer 5—The Application Layer. Applications such as ftp, telnet, SMTP, and NFS relate to this layer.

Layer 4—The Transport Layer. In this layer, TCP and UDP add transport data to the packet and pass it to layer 3.

Layer 3—The Internet Layer. When an action is initiated on a local host (or initiating host) that is to be performed or responded to on a remote host (or receiving host), this layer takes the package from layer 4 and adds IP information before passing it to layer 2.

Layer 2—The Network Interface Layer. This is the network device as the host, or local computer, sees it and it is through this medium that the data is passed to layer 1.

Layer 1—The Physical Layer. This is literally the Ethernet or Serial Line Interface Protocol (SLIP) itself.

At the receiving host the layers are stripped one at a time, and their information is passed to the next highest level until it again reaches the application level. If a gateway exists between the initiating and receiving hosts, the gateway takes the packet from the physical layer, passes it through a data link to the IP physical layer to continue. As a message is sent from the first host to the second, gateways pass the packet along by stripping off lower layers, readdressing the lower layer, and then passing the packet toward its final destination.

A router, like a bridge, is a device connected to two or more LANs. Unlike a bridge, however, a router operates at the network layer level, instead of the data link layer level. Addressing at the network layer level makes use of a 32-bit address field for each host, and the address field includes a unique network identifier and a host identifier within the network. Routers make use of the destination network identifier in a message to determine an optimum path from the source network to the destination network. Various routing algorithms may be used by routers to determine the optimum paths. Typically, routers exchange information about the identities of the networks to which they are connected.

When a message reaches its destination network, a data link layer address is needed to complete forwarding to the destination host. Data link layer addresses are 48 bits long and are globally unique, i.e., no two hosts, wherever located, have the same data link layer address. There is a protocol called Address Resolution Protocol (ARP), which obtains a data link layer address from the corresponding network layer address (the address that IP uses). Typically, each router maintains a database table from which it can look up the data link layer address, but if a destination host is not in this ARP database, the router can transmit an ARP request. This message basically means: “will the host with the following network layer address please supply its data link layer address.” Only the addressed destination host responds, and the router is then able to insert the correct data link layer address into the message being forwarded, and to transmit the message to its final destination.

IP routing specifies that IP datagrams travel through internetworks one hop at a time (next hop routing) based on the destination address in the IP header. The entire route is not known at the outset of the journey. Instead, at each stop, the next destination (or next hop) is calculated by matching the destination address within the datagram's IP header with an entry in the current node's (typically but not always a router) routing table.

Each node's involvement in the routing process consists only of forwarding packets based on internal information resident in the router, regardless of whether the packets get to their final destination. To extend this explanation a step further, IP routing does not alter the original datagram. In particular, the datagram source and destination addresses remain unaltered. The IP header always specifies the IP address of the original source and the IP address of the ultimate destination.

When IP executes the routing algorithm it computes a new address, the IP address of the machine/router to which the datagram should be sent next. This algorithm uses the information from the routing table entries, as well as any cached information local to the router. This new address is most likely the address of another router/gateway. If the datagram can be delivered directly (the destination network is directly attached to the current host) the new address will be the same as the destination address in the IP header.

The next hop address defined by the method above is not stored in their IP datagram. There is no reserved space to hold it and it is not “stored” at all. After executing the routing algorithm (the algorithm is specific to the vendor/platform) to define the next hop address to the final destination, the IP protocol software passes the datagram and the next hop address to the network interface software responsible for the physical network over which the datagram must now be sent.

The network interface software binds the next hop address to a physical address (this physical address is discovered via address resolution protocols (e.g., ARP, RARP, etc.), forms a frame (e.g., Ethernet, SMDS, FDDI, etc.—OSI layer 2 physical address) using the physical address, places the datagram in the data portion of the frame, and sends the result out over the physical network interface through which the next hop gateway is reached. The next gateway receives the datagram and the foregoing process is repeated.

In addition, the IP does not provide for error reporting back to the source when routing anomalies occur. This task is left to another Internet protocol, the Internet Control Message Protocol (ICMP).

A router will perform protocol translation. One example is at layers 1 and 2. If the datagram arrives via an Ethernet interface and is destined to exit on a serial line, for example, the router will strip off the Ethernet header and trailer, and substitute the appropriate header and trailer for the specific network media, such as Switched Multimegabit Data Service (SMDS), by way of example.

Data communications network services have two categories of call establishment procedures: connection-oriented and connectionless.

Connection-oriented network services require that users establish a single distinct virtual circuit before the data can be transmitted. This circuit then defines a fixed path through the network that all traffic follows during the session. Several packet switching services are connection-oriented, notably X.25 and Frame Relay. X.25 is the slower of the services, but has built-in error correction—enough for its performance not to depend on clean, high-quality optical fiber lines. Frame relay, regarded as the first generation of fast packet technology, is well-suited for high-speed bursty data communication applications.

Connectionless network services, by contrast, let each packet of a communications session take a different, independent path through the network. One example is the SMDS, a possible precursor to broadband ISDN. This fast-packet service supports data rates ranging from the TI rate of 1.544 Mb/s up to 1 Gb/s. The SMDS transport system architecture is defined by IEEE 802.6 Metropolitan Area Network standards.

Eventually, SMDS is expected to operate at rates of 51.85 Mb/s to 9.953 Gb/s specified by the family of standards known in North America as Synchronous Optical Network (SONET). Synchronous Digital Hierarchy (SDH) is an ITU recommendation that grew out of and includes the specifications of SONET.

The process of routing packets over the Internet is also considered a connectionless network service. The Internet Protocol (IP) addresses packets from sender to receiver. It is still used mostly in conjunction with the Transmission Control Protocol (TCP), which establishes a connection between end users to manage the traffic flow and ensures the data are correct, providing end-to-end reliability. The combination, known as TCP/IP, is the Internet's main backbone protocol suite.

### SUMMARY OF THE INVENTION

The present invention provides a protocol which provides network, transport, session and presentation layers of the open systems interconnection model.

The present invention also provides a protocol which supports messages originating as far afield as an external personal computer (PC), transmitted directly to an access port such as a modem and then to any target module within the network.

The present invention in another embodiment provides a network layer protocol (NLP) which contains sufficient addressing information to allow the target module to return a response to the originating module's access port. From there the response is returned to the external PC. There is no inherent limitation preventing module to module communications within the protocol's definition.

In accordance with one embodiment of the present invention, this protocol ensures error free delivery of data to a specified destination, provides the ability to have multiple concurrent sources sending to any destination, and the ability to send a single transmission packet to any destination within seconds.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows the protocol format of one preferred embodiment of the present invention.

FIG. 2 is a flow chart showing system connection pathways and protocols of one preferred embodiment of the present invention.

FIG. 3 is a data flow chart showing a routine with double buffering of one preferred embodiment of the present invention.

FIG. 4 is a data flow chart showing a routine without double buffering of one preferred embodiment of the present invention.

FIG. 5 is a data flow chart showing a routine of Call-Back with double buffering of one preferred embodiment of the present invention.

FIG. 6 is a data flow chart showing a termination with double buffering of one preferred embodiment of the present invention.

FIG. 7 is a data flow chart showing a forced termination with double buffering of one preferred embodiment of the present invention.

FIG. 8 is a data flow chart showing a transport with double buffering followed by a data request without double buffering of one preferred embodiment of the present invention.

FIG. 9 is a data flow chart showing a destination drops packet with double buffering of one preferred embodiment of the present invention.

FIG. 10 is a data flow chart showing a nacked packet with double buffering of one preferred embodiment of the present invention.

### DETAILED DESCRIPTION OF PREFERRED EMBODIMENTS OF THE INVENTION

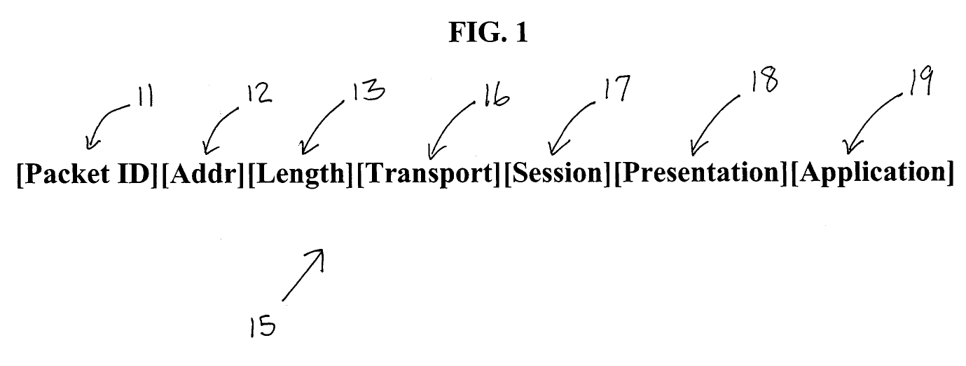

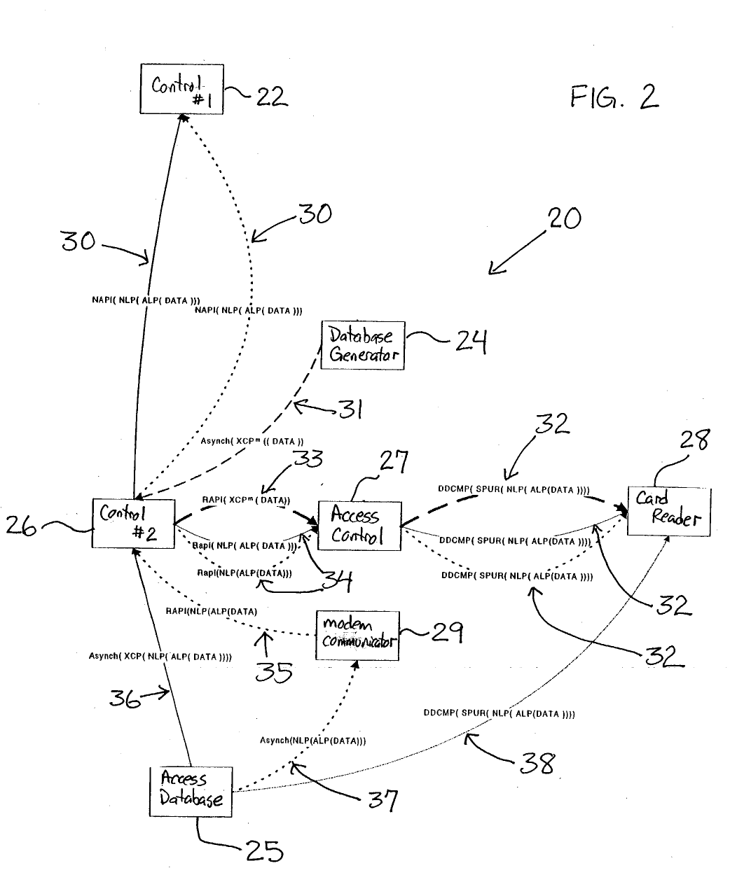

Referring to FIG. 1, the invention provides a network layer protocol (NLP) 15. Referring to FIG. 2, this protocol is intended to be encapsulated within various physical and data link layer protocols 30, 31, 32, 33, 34, 35, 36, 37, 38 as it spans each network link 22, 24, 25, 26, 27, 28, 29. Data will propagate over 8-bit Asynch data lines 31, 36, 37, 9-bit and RAPI 33, 34, 8-bit and NAPI 30 or IPL protocols.

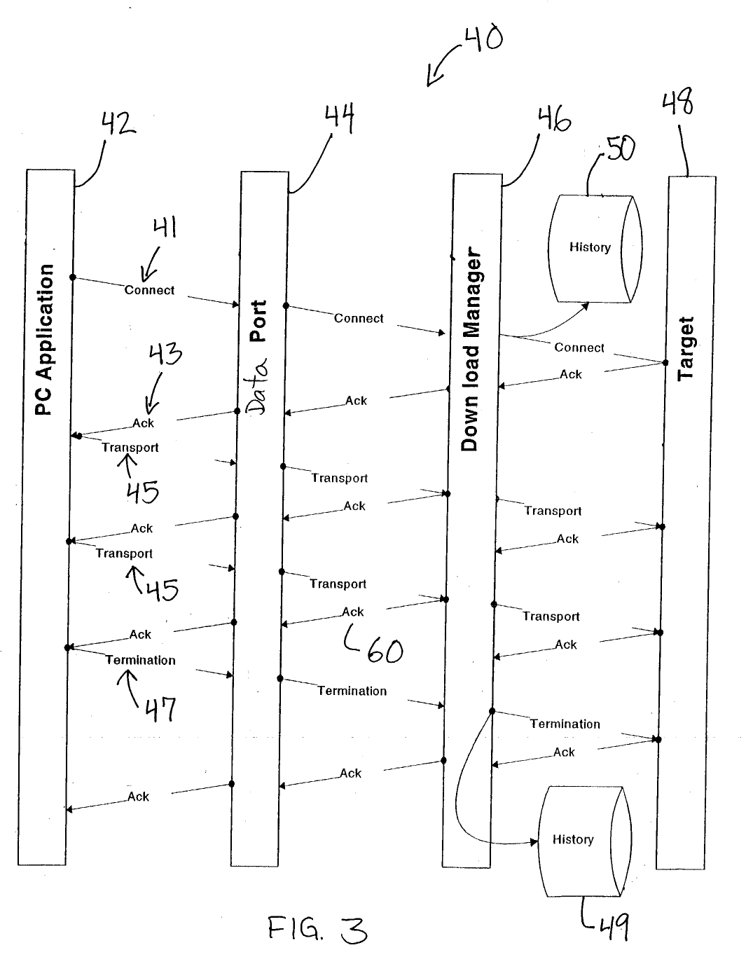

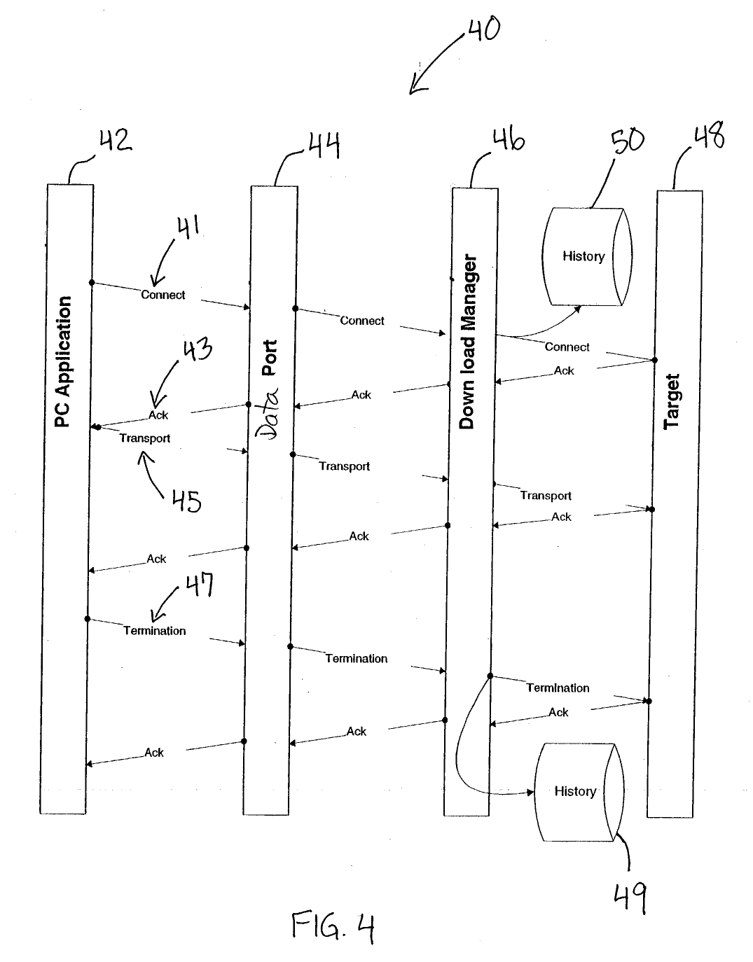

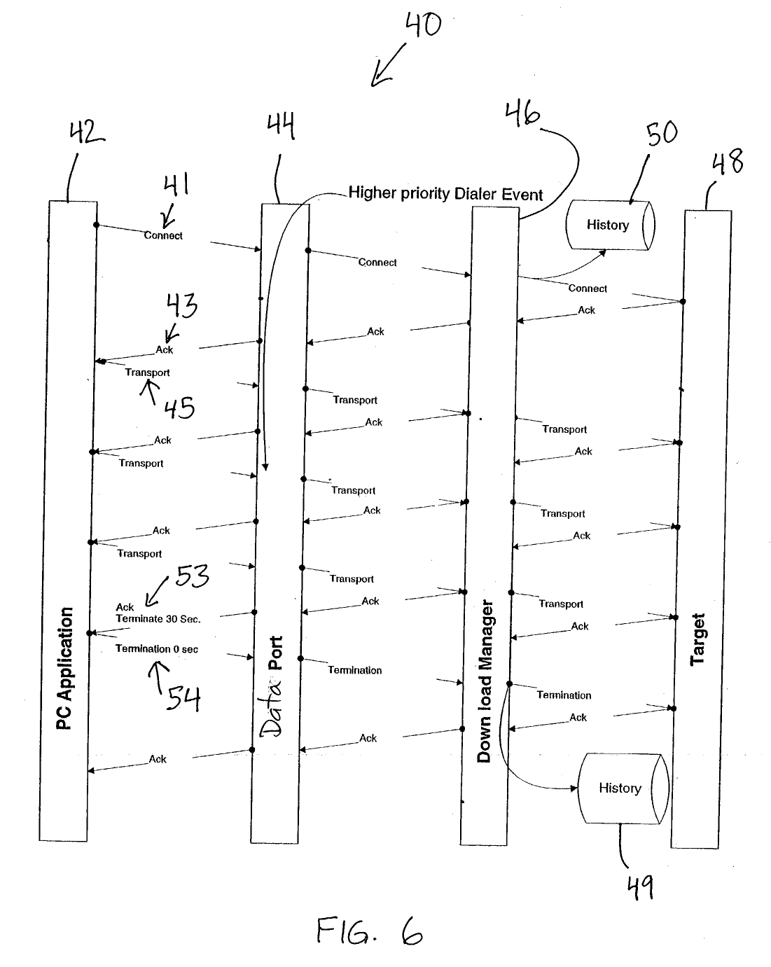

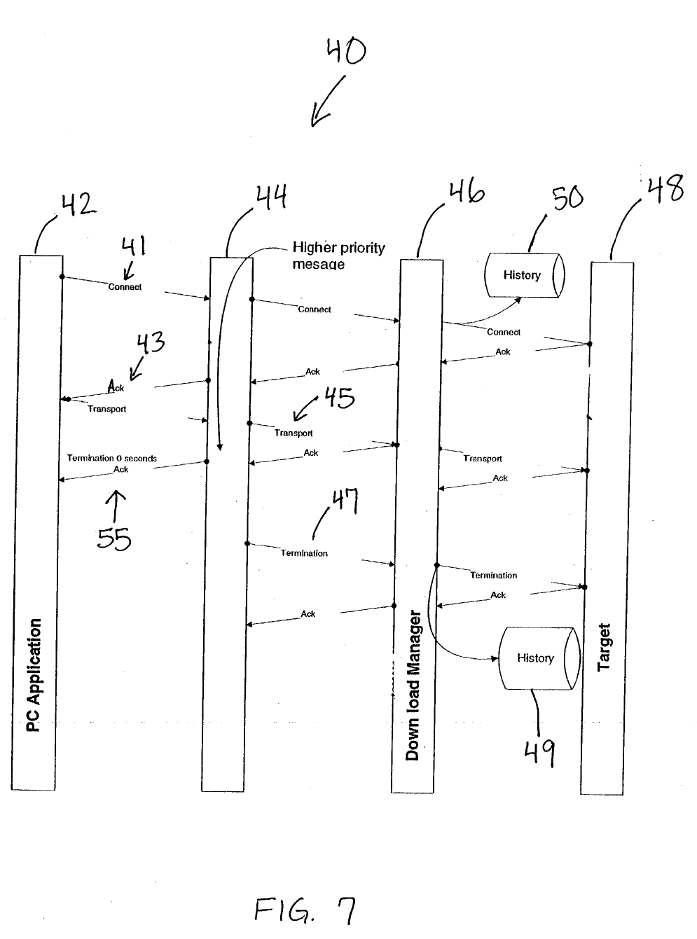

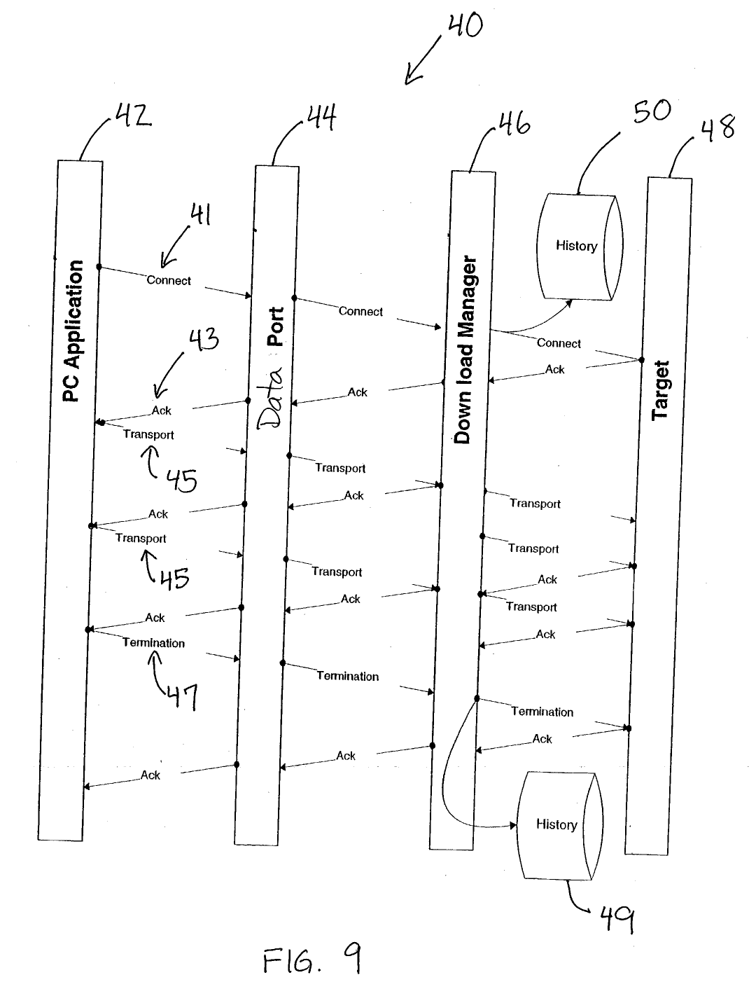

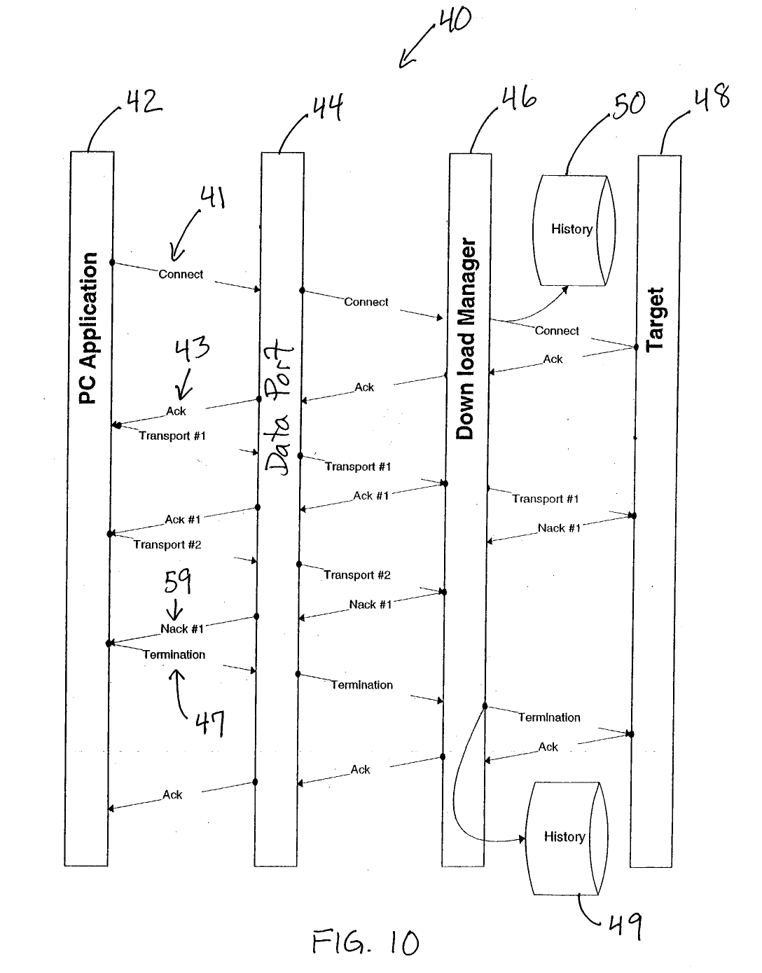

Referring to FIGS. 3-10, there are two categories of propagation paths within the system. The external path or data flow 40 is the link between the PC application 42 and data port 44 along with a download manager 46. This is an implied network link as the PC is not addressed within the message (only the access port is addressed).

The internal path is from the connecting module's data port, 44 traversing the network and rail topology to a final target 48 module and back to the connecting module's port.

Due to the self-routing nature of this protocol, session level timing is not required for any media management sub-system. The timing requirements of each physical link within the physical layer is dependent on its individual specifications. Referring again to FIG. 2, for example, a Modem/Communicator 29 must provide the network layer protocol (NLP) 15 packet to the Controller 22, 26 within the response specification for the Rail Protocol. This is a physical link requirement. But at the session level there is no timing constraint on the acknowledgement to the NLP 15 packet. Any functional house keeping shall be done after five (5) minutes of dormancy. Both target and source will be independently responsible for meeting timing issues.

Referring again to FIG. 1, the NLP 15 can be of a basic format as shown. The first three segments of the packet, the Packet ID 11, address 12 and length 13 can be in a fixed format. The segment transport layer 16 can also be in a fixed format. The packet segments session 17, presentation 18 and application 19 are optional. When not required, a single zero or null byte is provided otherwise the format of the segment is variable and described in later herein. Note that NLP 15 is always encapsulated within another physical layer protocol which must be parsed to extract the NLP 15 packet.

The Packet ID 11 identifies the primary purpose of each packet and is 1 byte in size. The Address 12 contains the packet's destination and originating source addresses and is 6 bytes in size. The Length 13 is the total number of bytes remaining and is 2 bytes in size. The Transport layer 16 contains transport layer data 56 and is mandatory with varying size. The Session layer 17 contains optional session information and is varying in size. The Presentation layer 18 is optional and contains presentation layer data with varying size. This layer modifies how the application layer is to be interpreted. The Application layer 19 is optional and contains application layer data such as application level commands or responses and has varying size.

The packet sizes that may be propagated need to be scaled depending on their source and destination. The maximum packet size for any NLP 15 frame sent to or from a data port is about 64 kilobytes minus overhead. The overhead may include an XCP header. Packets that do not propagate through the data port but through the rail are limited to 1024 bytes, minus the rail overhead of 7 bytes. The length definition in the PACKET FORMAT section includes an NLP 15 overhead of 9 bytes plus a pad. The is represented from the perspective of the length variable within the frame.

In Packet identification 11 indexes, each packet will contain an identifier. This identifies each packet's specific purpose. Packets may be considered commands, those NLP 15 packets that originate at the PC and responses, i.e., NLP 15 packets returning to the PC. NLP 15 is a master-slave protocol. The PC Application 42 is the master and requires a response to valid NLP 15 packets before proceeding. NLP 15 packets that appear incorrectly formatted are to be discarded. It is the responsibility of each leg in the session to perform the appropriate timeout and recovery operation.

The NLP 15 packet contains two addresses. The destination address which is always the module to which the packet is to be delivered and the source address which is generally the message origin, e.g., Modem/Communicator 29.

For example, in the case of direct Controller 22, 26 connections, the Card/Panel/Sub addresses will be set to 0×FF by the PC Application 42 in the connect command. The Controller 22,26 will replace these with the correct internal addresses. The Acknowledge 43 to the Connect 41 command will contain the current Controller 22, 26 Panel/Card/Sub addresses. The PC Application 42 will use those addresses in subsequent communications for that session including the Terminate 47 and hang-up commands. The PC Application 42 will return to the 0×FF addressing for additional Connect 41 commands. The source and destination addresses are reversed whenever a message is turned around, typically for an acknowledgement 43 to a command. During intermediate transport within a module these addresses remain intact.

As previously stated, each NLP 15 packet contains four functional layers, transport 16, session 17, presentation 18 and application 19. This layer sequence is fixed and all layers must be accounted for in one form or another. A null (single byte) at a given layer position indicates the layer is not utilized. A non-zero value indicates that this layer is being utilized. A non-zero layer contains Type Length Value (TLV) encoding. The initial bits indicates which of the four TLV encoding formats this layer uses (the single byte null could be considered a fifth format type). The next 8 to 13 bits contain an index which specifies the format or type index for the layer's data or value. Depending again on the TLV encoding format, the next one or two bytes contains the length of the value/data field. The remaining bytes are the data for the TLV value.

The transport 16 layer along with the network addressing 12 layer contains the information required to deliver a command from the PC application 42 to the target 48 module. These two layers are also used by the target 48 to construct the network and transport layers for the response, typically an acknowledgement 43.

For end-to-end transmission the Acknowledge response indicates the source was received correctly and then executes the command 43 associated with the transport 16 layer sequence number. The transport 16 layer is mandatory for an acknowledge response. Session 17, presentation 18 and application 19 layers may be inserted to indicate changes in the session status or return data from the target 48. An acknowledgement 43 with data from the target 48 will contain an application 19 layer and if required the target 48 will also insert a presentation 18 layer. A session 17 layer such as terminate 47 may be inserted by the connecting port 44 as required.

A Source Identifier bit is set for transmissions from the PC and cleared for transmissions originating from the access control unit 27. This bit is used only by the Controller 22, 26 and otherwise does not affect transmissions or addressing.

Referring to FIGS. 3 and 6-10, Double Buffer Disable is primarily controlled by the originating PC Application 42. When this bit is set to one (disabled) the NLP 15 packet is transmitted end-to-end. That is to the destination address and the destination or target 48 module creates the acknowledge 43 packet. Double buffering is disallowed for Session Connect 41 and Session Terminate 47 packets.

When the Double Butter Disable bit is cleared to zero the packet can be double buffered by the Controller 22, 26, however it will affect the acknowledge sequence as noted below.

The Buffered Acknowledge (Ack) 60 bit is used internally only by the Controller 22,26 for acknowledge packets that it creates during the double buffering process. The Buffered Ack 60 bit is cleared at the PC Application 42 and target 48 modules for all created transmission. The Buffered Ack 60 should be ignored and passes along by all other modules.

The History 49, 50 Written bit is used internally by the Controller 22, 26. It should be cleared for all transmissions from the PC application 42. The Controller 22, 26 will set this bit for all packets that are logged to its history 49, 50 buffer. The target 48 module must set this bit according to the state of the original command. It should be ignored and passed along by all other modules. The access port will Nack 59 (negative acknowledge) all messages not containing a format 1 transport layer.

Each packet contains a packet number that is used to ensure that the correlated packet makes acknowledgements. All packet transmissions fall into two categories, requests and responses. All request packets sent will receive a response and each response will contain the packet number of the request that it is responding to.

The master PC application 42 will assign the sequence number to the originating command. The initial number is arbitrary. For end-to-end transmission the sequence number will be maintained throughout and the target will use the sequence number in the Acknowledge 43 command indicating correct receipt of the command. For end-to-end transmissions the assignment of numbers is arbitrary although making the numbers sequential is recommended.

For doubled buffered transmission, the sequence numbers must be in sequential order for acknowledgement tracking by the controlling Controller 22, 26. The Controller 22, 26 will be the first Controller 22, 26 encountered by the PC Application 42 generated NLP 15 packet on it's way to the target 48 module.

(For the following it is implied that the “command” is a command with a specific sequence number and the Ack or Nack for a command contains the same sequence number. And that “next” and “previous” are associated with packet numbers plus and minus one, respectively.)

For nominal transmission the Controller 22,26 returns an NLP 15 Ack packet 43 to the PC Application 42 for the first double buffered command. The Controller 22, 26 transmits the command to the target 48 and awaits the Ack/Nack from the target 48; and the Ack/Nack is pending. Once received the Ack/Nack status is recorded along with its sequence number. The next PC command is received and assuming the previous Ack/Nack status is Ack then the procedure is repeated. Note that the target's Ack to the initial command is discarded at the Controller 22, 26.

If the next PC command is received while the Ack/Nack is pending then the Controller 22, 26 buffers it until the Ack/Nack is received and the transmission sequence resumes.

If the target 48 returns a Nack 59 for the originating command then the Controller 22,26 returns the Nack 59 as the response for the next PC Application 42 command. The command itself is discarded. To recover, the PC Application 42 must re-send the original command whereby the Controller 22, 26 will return to the nominal sequence as described above.

It should be noted that the PC Application 42 may receive an Ack 43 and then a Nack 59 for a given command's sequence number, the Nack 59 indicates that the command (per the sequence number) was unsuccessful and that the current command sent has been discarded.

For double buffering, the Controller 22, 26 will always forward a command with the current Ack/Nack sequence number. The Controller 22, 26 will forward the command with the next higher sequence number once the target Ack for the previous command is received. The Controller 22, 26 will always forward Connect 41 commands and reset the command sequence number.

Out of sequence double buffered commands will be Nack'd with the out of sequence command number and then discarded. This includes sequence numbers less than the current Ack 43 sequence number except at roll over (255 to 0) and those two or greater than the Ack 43 sequence number.

If the Controller 22, 26 Nack's a double buffered command then the PC must issue a command with the preceding sequence number or clear the sequence number check in one of three ways: the following (1) send a double buffered packet with the special sequence number zero indicating that sequence numbers are to be restarted; (2) send an end-to-end non-double buffered transmission; or (3) terminate and re-connect the session.

The double sequence buffering is reset by the Connect command and an end-to-end command after an acknowledged double buffer command. The first end-to-end transmission after a double buffered command is considered to be double buffered will be sent if the previous double buffered command is Nack'd.

The session layer provides information spanning the current sequence of NLP 15 traffic for the connecting port of the host Controller 22, 26 and the target 48 module.

For example, the connect session layer value provides information to authorize the connection between the PC Application 42 and target 48 module and the Controller 22, 26 can log the granting of authorization in its history 49, 50 log. Once granted the authorization applies to the entire sequence of commands until some action such as terminate session value, another connect value or possibly a forced hang-up occurs to change the authorization.

A requestor's company ID index is supplied by the PC application 42 in the connect session layer as part of a connect 41 command. It allows the specific Modem/Communicator 29 (or Controller 22, 26) to locate the password seed and assigned access levels for the current session.

For systems with less than 255 companies the requesting index can indicate the specific company regardless of the number of modem/communicators used.

For systems with multiple modem/communicators containing different configurations, i.e., more than 255 different Company ID's, the password seed and access levels for a given index on one module will be different than on another. The Controller 22, 26 can log connection and termination commands based on the connection port and Company ID.

When it comes to session type, the PC will supply a Session Type with the connect session type. A value of bxxxO is a regular connect session where the PC Application 42 will terminate the session with a terminate 47 packet. A value of bxxxl is a connect/disconnect session where the PC does not terminate the session. The destination module/device does not wait for a terminate packet. The session is automatically terminated after the reply is sent to the PC.

When it comes to Payload Type, the PC will supply a Payload Type with connect and terminate session values. The Payload Type will set the default session priority level and is used by the Controller 22, 26 when logging to the history buffer.

Referring to FIG. 2, the Database Generator 24 will create a Unique Project Identifier (UPID). This will be an 8-byte value. It uniquely identifies the Project (and only the project). All other Applications/Subsystems will use this when they wish to verify that they are communicating with another Application/Subsystem configured for the desired project.

An example of this is when the Card Access Database (CADB) 25 calls a Modem/Communicator 29, the UPID is exchanged (and used in the Card Reader Code (CRC) ) to verify that the Modem/Communicator 29 is associated with the correct project. This of course does not resolve multiple modem/communicators on a project, the panel and card must be used to resolve modem/communicators within a project.

The applications that use the UPID should not depend in any way on the format of the value, other than that it is 8 bytes, it is unique, and the any 2 UPIDs can be compared for equality.

The 8 Bytes are needed to ensure uniqueness. It will uniquely identify the HASP KEY being used when the project is created (will use 4 bytes for this). It will use the other 4 bytes to provide uniqueness within the key. These second 4 bytes should not be randomly selected. They may provide a unique time stamp, or a unique count of created projects (the count would be stored & tracked within the key itself).

The Access level is supplied by the connecting port. It is constantly retrieved from configuration tables based on the requesters company index (not shown). Access level is granted by the connecting port when the session connection is authenticated. It represents the maximum privileges permitted for the session. The target module 48 uses this value as a check against application layer commands. For example, if the access level reports only that the PC application 42 attempted a data base modification, the target 48 module would Nack 59 the request. The PC Application 42 will set this value to the desired access level. For password protected connections such as via the phone line, the connecting port will overwrite the access level with the value attached to the password. In physically protected connections such as a direct connect to the Controller 22, 26 where a password does not apply, the value will be forwarded unchanged.

Within the Control System 20, passwords are never sent over the communication link. The PC based password is used at the PC to generate a password seed (16 bit). This password seed is supplied to the connecting port at configuration time. When connecting the user will supply their password, at the PC, in text form. The PC will use this to regenerate the password seed (wrong password—wrong seed). The PC will continue with this seed and process the balance of the authentication data to generate a passed CRC value. The connecting port already has the correct seed for the given Requesting Company's ID. The connecting port begins with this seed, processes the balance of the authentication data and compares the results for a match with the CRC passed in the connect session layer. In physically protected connections such as a direct connect to the Controller 22, 26 passwords do not apply. The PC will compute and insert a password but it will be ignored.

PC Application 42 Password Text may be derived by many means. For this discussion, only one will be defined. This password will be created from an ASCII data string with a minimum length of 4 characters and a maximum length of 128 characters. All characters must be within a range from ASCII 1 to ASCII 127. This is stipulated to guarantee storage within some database formats as strings. The password seed will consist of a 16 bit value. The seed will be built by generating a CRC 16 for the entire password string. The resultant will constitute the password key.

The PC based password is used at the PC to generate a 16 bit password seed. This password seed is contained in the connecting port module's configuration data base. A separate seed is used for each requesting company index. Beginning with the password seed a CRC is computed to be compared with the connect session layer CRC field. The CRC is computed before any link layer (ASYNC protocol) transformations are performed.

The CRC will be calculated as follows:

PC Session 17 Layer CRC=

PC base CRC seed+converted (non-passed password string)+

NLP packet bytes from the Command ID through to but not including the session layer CRC itself;

Modem/Communicator 29 Authentication CRC=

Password seed [Company ID]+

NLP packet bytes from the Command ID through to but not including the session layer CRC itself;

The bytes of the NLP 15 include all addressing bytes and the UPID among other items.

The connection will be validated if the session layer CRC matches the computed CRC and the session layer UPID matches the configured UPID.

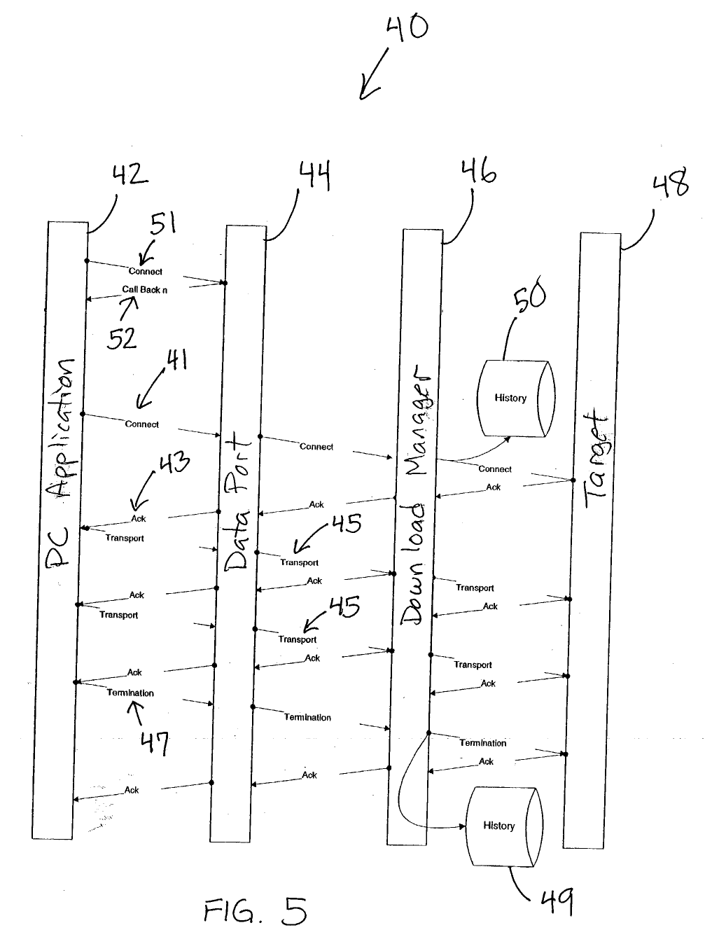

Referring to FIG. 5, Callback 52 wait time is assigned by the connecting port. This is the number of seconds (n) the PC should wait before attempting to call back. It typically allows the Modem/Communicator 29 a window of time in which the Customer Monitoring station may be notified.

The call back 52 acknowledgement packet allows the connection port the ability to instruct the connecting application to disconnect and attempt a reconnect in a specified number of seconds. The Call Back 52 must contain a Timeout session layer with the Time to Hang-up field set to zero. Subsequent commands will not be accepted from the PC during this phone call.

Referring to. FIGS.. 6 and 7, time to hang-up is assigned by the connecting port. This is the number of seconds before the connecting port will forcibly hang-up. It can be used during the initial connection sequence in conjunction with the Callback Wait Time to refuse the connection, hang-up the call immediately and request the PC to call back in a specified interval. The Timeout session layer value is also inserted by connecting the port into an acknowledgement when the Modem/Communicator 29 must use the phone line to service a dialer message. Here the Time to Termination 53, 54, 55 allows a grace period for the PC to close out it's session. All subsequent acknowledgements will contain the Timeout session layer with the connecting port decrementing Time to Termination. If the Time to Hang-up is set to zero the connecting port will hang-up as soon as the transmission is complete. The PC need not issue a hang-up command.

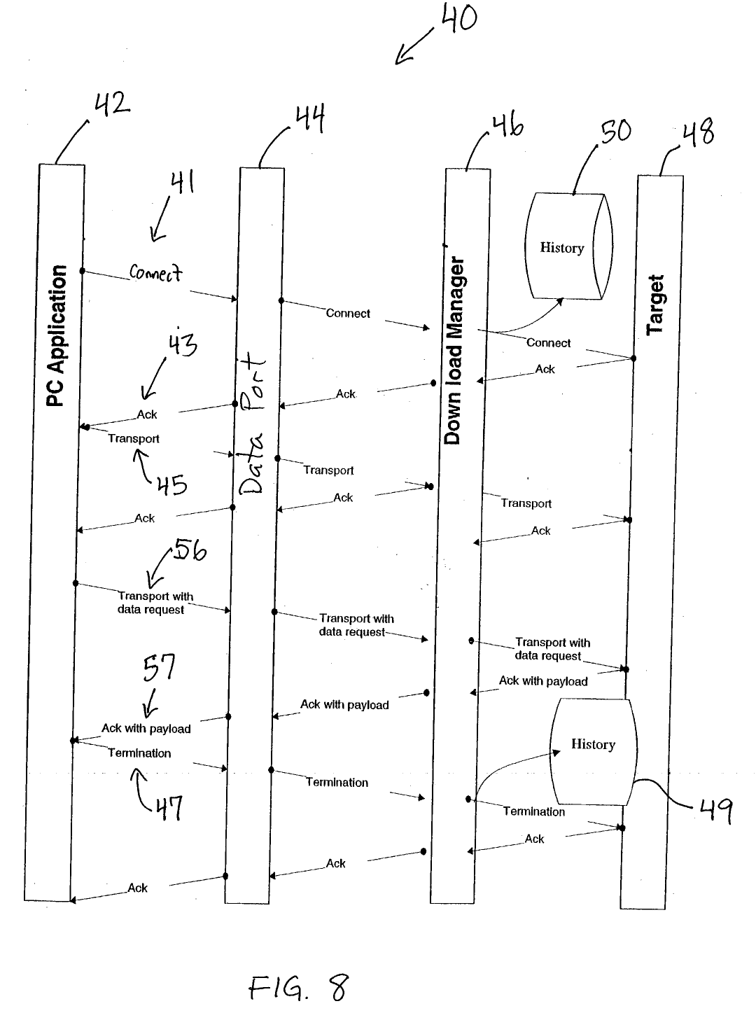

Referring to FIG. 8, each payload 57 type as supplied in the connect session layer has a default priority associated with it. The session begins with this priority. Once connected, the application can assign a higher new priority with the external priority session layer to ensure continuous communications. Priorities are weighted from the highest priority 0 to the lowest priority of 255. However, once a timeout session layer value has been issued the connecting port will ignore future priority change requests.

The PC Application 42 will insert a Connect Session 17 layer only into a Connect 41 command to initiate a connection with a target. The connecting port provides session authorization and sets the Access Level field before forwarding the Connect 41 command. The Connect Session 17 layer remains intact until reaching the target 48. The reciprocal is the Terminate Session 17 layer and is provided by the PC only in a Terminate 47 command. The Terminate Session layer is logged to the history buffer 49, 50 by the Controller 22,26 and passed to the target for session closeout as well.

In a Modem/Communicator 29 a session will be terminated if a Terminate Session 17 layer is received or a Connect Session 17 is received or the phone line connection is severed. Connect and Terminate Session 17 layers are not returned in the Ack or Nack commands from the target. The Timeout Session is generated only by the connecting port and inserted into an Ack or Nack being returned to the PC. The External Priority Session layer is created only by the PC and is supplied only in a Transport Command but is not mandatory. This session layer is consumed by the connecting port. The Transport 16 Session layer is inserted by the connecting port into every Transport Command reiterating the Company ID Index and Access Level set during the connect sequence. This session layer is propagated to the target module. It should be noted that care must be taken when using the Company ID to identify the session data stream when multiple Modem/Communicator 29 are in use.

The Presentation 18 layer provides information about the presentation of the date in the application layer. This layer applies only to the application layer of the current NLP 15 packet. It is optional and when not supplied the data layer is assumed to be unencrypted non-compressed data. Currently only the Encryption TLV is defined. It allows the target recipient the ability to decompress and or decrypt any received application 19 layer data. The source of the application 19 layer data is responsible for the presentation 18 layer. This will be the PC application 42 and the target module 48. The presentation layer is propagated unchanged between source and destination.

The requirements for encryption within Control System 20 integration have been specified to provide the ability to utilize up to a 56-bit key. The following encryption methods are currently available.

Type 0: No encryption utilized.

Type 1: The encryption and decryption of data will be accomplished by utilizing a 32-bit key that resides in both the connecting application and the destination. All data will be XOR'd with the key for both the encryption and decryption process. Modulus 4 remainder data will be XOR'd with a scaled key. The scaling of the key will be accomplished by removing Byte(s) starting from the most significant byte of the key.

The application 19 layer provides space for application data. It is optional and may be supplied in any NLP 15 packet. The definition ofthis layer will be defined by the Access Database 25 design documentation. It is the responsibility of the PC application 42 and the target module 48 to agree on the format and use of the application 19 layer data. To provide security of operation it is the responsibility of the target module 48 to ensure that actions resulting from the application 19 layer data do not exceed the session rights as granted during connection. The presentation 18 layer is propagated unchanged between source and destination.

The connection packet provides a mechanism for the PC to secure a connection with a target application. Specific functionality of the “connect packet” includes the following:

Ensure that the contacted Modem/Communicator 29 port is the intended port

Ensures that the user requesting connection has authorization to connect and that the activities requested are within the user's defined rights. Provides a vehicle for future functionality. This includes providing the destination the ability to do a secondary authorization and provide an encryption modifier.

A method for saving historical data.

A Connect Packet contains a Connect Session 17 layer which provides the functional data for the connect command. A Connection Packet must be an end-to-end transmission and it will reset any double buffering sequence in the Controller 22, 26.

The termination packet provides a method for closing off the current session and logins any results to the history buffer 49, 50. It must contain a Terminate Session 17 layer. A Termination Packet must be an end-to-end transmission. The termination packet frees a session handler within the Controller 22, 26.

A Transport 16 Packet is the primary means of transporting data within the Control System 20. This originates at the PC Application 42 and is propagated through the Modem/Communicator 29, Controller 22, 26 AUX or RJ ports to the target 48. A Transport Packet virtually always contains an application 19 data layer. It may be transmitted in double buffered or end-to-end fashion as the PC requires.

Some valid NLP 15 packets require a negative acknowledgement (Nack) 59. Typically the target will generate a Nack when an application 19 layer instruction is not complied with. Any reason code information for the Nack will be supplied within the application layer in the same way response data is created.

A Hang-up Packet provides an indicator to the connection port that the connection is being terminated. This allows the PC and connecting port to disconnect in unison. The access port will respond to this command with an Ack, Nack or Callback response possibly containing a timeout session layer. This facilitates the PC shutdown sequence. The access port will close down within one second.

Double buffering protocol will be implemented as half duplex. Double buffering is not defined as part of the protocol, but considerations have been made to aid in its implementation.

The many features and advantages of the invention are apparent from the detailed specification, and thus, it is intended by the appended claims to cover all such features and advantages of the invention which fall within the true spirits and cope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A network protocol, comprising:
a packet identification data segment;
an address data segment;
a length data segment; and
a transport data segment,
wherein the network protocol is encapsulated within a physical layer protocol which must be parsed to extract the network protocol.

2. The network protocol as in claim 1, further comprising:
a session data segment;
a presentation data segment; and
an application data segment,
wherein each segment have varying size formats.

3. The network protocol as in claim 2, wherein the packet identification data segment is one byte in size and identifies the primary purpose of each packet.

4. The network protocol as in claim 2, wherein the address data segment is six bytes in size.

5. The network protocol as in claim 2, wherein the length data segment is two bytes in size and indicates the total number of bytes remaining.

6. The network protocol as in claim 1 has a maximum size of about 64 kilobytes minus overhead.

7. The network protocol as in claim 2, wherein the address data segment contains two addresses.

8. The network protocol as in claim 2, wherein the address data segment comprises a source address and a destination address.

9. The network protocol as in claim 2, wherein the transport data segment, the session data segment, the presentation data segment and the application data segment are sequentially fixed in position and must be accounted for within the network protocol packet.

10. The network protocol as in claim 9, wherein a single byte null at a given data segment sequential position indicates that the segment is not utilized.

11. The network protocol as in claim 9, wherein a single byte non-zero value at a given data segment sequential position indicates that the layer is being utilized.

12. The network protocol as in claim 9, wherein the physical layer protocol interconnects a data network comprising:
a controller;
a database generator;
a modem/communicator;
a card reader;
an access control; and
an access database.

13. The network protocol as in claim 9, wherein the presentation data segment provides information about the presentation of the data in the current application data segment.

14. The network protocol as in claim 2 is a master-slave protocol, wherein a personal computer application is the master and requires a valid response before proceeding.

15. A method of addressing a data network, comprising the steps of:
identifying the primary purpose of a packet;
providing originating and destination source addresses;
identifying total number of bytes remaining in the packet; and
identifying information required to deliver a command from a computer application to a target module.

16. The method of claim 15, further comprising the steps of:
maintaining session data;
maintaining application data commands and responses; and
modifying said application data for presentation.

17. The method of claim 15, wherein the data network comprises:
a controller;
a database generator;
a modem/communicator;
a card reader;
an access control; and
an access database

18. A network protocol packet, comprising:
means for identifying the primary purpose of each packet;
means for providing originating and destination source addresses;
means for identifying total number of bytes remaining in the packet; and
means for identifying information required to deliver a command from a computer application to a target module

19. The network protocol packet of claim 18, further comprising:
means for maintaining session data;
means for maintaining application data commands and responses; and
means for modifying said application data for presentation.

20. The network protocol packet of claim 19 interconnects a data network comprising:
a controller;
a database generator;
a modem/communicator;
a card reader;
an access control; and
an access database.
